(19) United States
(12) Patent Application Publication
(10) Pub. No.: US 2005/0108654 A1
(43) Pub. Date: May 19, 2005

(54) Method, system and program product for processing requests in a web application

(75) Inventor: Ramajeyam Gopalraj, Nashua, NH (US)

Correspondence Address: HOFFMAN WARNICK & D'ALESSANDRO, LLC, 3 E-COMM SQUARE, ALBANY, NY, 12207, US

(73) Assignee: International Business Machines Corporation, Armonk, NY (US)

(21) Appl. No.: 10/712,835

(22) Filed: Nov. 13, 2003

(51) Int. Cl. G06F 3/00

(52) U.S. Cl. 715/791; 715/790; 715/793; 715/794; 715/795; 715/796; 715/802; 715/808; 715/809; 715/807; 715/741; 715/743

(57) ABSTRACT

An improved solution for processing requests in a web application. In particular, the invention provides a method, system and program product that ensure that a page, such as a login page, that may be displayed as a result of the request is displayed in a top level window. In this manner, the invention helps ensure that the window used to display the page is of a sufficient size and/or is resizable to properly display the page.

### BACKGROUND OF THE INVENTION

1. Technical Field

The invention relates generally to processing requests in a web application, and more specifically, to a method, system and program product for processing requests in a web application in which it is ensured that a page, such as a login page, is displayed in a top level window.

2. Background Art

Web applications are becoming increasingly popular. A web application is an application that is stored on a server, and portions of which are downloaded to a client each time it is executed. In general, one or more pages are provided from the server to the client for display. The pages can be displayed on the client using one or more windows managed by standard software such as a web browser. Each page typically includes data such as text, images, audio, or the like. A page may also include one or more items for accepting input from a user, a small amount of source code, and/or a link, each of which may generate a request when operated by the user. The request can be sent to the server for processing, and the server can communicate a response to the client when processing is complete. The response may include one or more additional pages that are to be displayed on the client.

As web applications have become more complex, the types of pages generated have also become more complex. Frequently, rather than displaying a single page, a web application may simultaneously display two or more pages in separate windows. Depending on the purpose of these pages, each window may be generated with a default size, and may or may not be resizable by the end user. Further, the windows may have a hierarchical relationship, and may be modal or non-modal.

One reason for the popularity of web applications is their ability to readily interface with centralized databases and generate pages based on data that is retrieved from these databases. This flexibility allows institutions to offer, for example, online banking, on demand access to asset statements, etc. without requiring their customers to install customized software. Frequently, these databases require that a user provide some type of identification before accessing the data. One popular solution for identifying the user is for the user to “login.” Typically, a user is presented with a login page that requests a user name and corresponding password. Once this information is provided, the information is checked against a set of authorized user name/password pairs. If the user name/password pair is found, the user can be allowed to access data in the database.

In order to prevent unauthorized access, a database may require that a user re-login even though the user has previously successfully logged in. For example, an amount of time since the last request was received from a client may be tracked. Subsequently, should the amount of time indicate that a new request to access to the database occurs after a specified time out period, the user can be required to provide a valid user name/password via the login page before access to the database is again permitted. Typically, the login page is displayed in the currently active window for the web application.

However, displaying the login page in the currently active window can be problematic when a request is generated from a child window. For example, the child window may be created in a smaller size configured to display a small amount of information. In this case, the child window may not be large enough to properly display the login page. Further, the child window may not be resizable. In any event, these situations often cause the user confusion and/or frustration with the web application when a login page is displayed in these windows.

As a result, a need exists for an improved solution for processing requests. In particular, a need exists for a method, system and program product for processing requests that ensures that a login page or the like will be displayed in a top level window.

### SUMMARY OF THE INVENTION

The invention provides an improved method, system and program product for processing requests in a web application. In particular, the invention provides a solution for ensuring that a page that may be displayed as a result of the request is displayed in a top level window. Specifically, under the present invention, a request may result in a login page or the like being provided to a client for display. The page can specify that it is to be displayed in a top level window. As a result, the ancestor window(s) for the active window can be located until an ancestor window is found that does not have a parent window, i.e., the ancestor window is a top level window. The page (e.g., login page) can then be displayed in the top level window. If the top level window has been closed, a new top level window can be created for displaying the page. Further, the active window and one or more ancestor windows can be closed so that the top level window becomes the active window for displaying the page.

A first aspect of the invention provides a method of processing a request in a web application, the method comprising: obtaining a request that requires authentication; locating an ancestor window for an active window of the web application; and displaying a login page in the ancestor window.

A second aspect of the invention provides a method of processing a request in a web application, the method comprising: receiving the request from a client; determining that the request requires authentication; and providing a login page to the client, wherein the login page ensures display in a top level window.

A third aspect of the invention provides a system for processing a request in a web application, the system comprising: a communication system for receiving the request from a client; a request system for determining whether the request requires authentication; and a login system for ensuring that a login page is displayed in a top level window for the web application.

A fourth aspect of the invention provides a program product stored on a recordable medium for processing a request in a web application, which when executed comprises: program code for obtaining the request from an active window for the web application, wherein the request requires authentication; program code for locating a top level window for the web application; and program code for displaying a login page in the top level window.

The illustrative aspects of the present invention are designed to solve the problems herein described and other problems not discussed, which are discoverable by a skilled artisan.

### BRIEF DESCRIPTION OF THE DRAWINGS

These and other features of this invention will be more readily understood from the following detailed description of the various aspects of the invention taken in conjunction with the accompanying drawings in which:

FIG. 1 shows an illustrative system for processing web application requests according to one embodiment of the invention;

FIG. 2 shows an illustrative set of windows for a web application;

FIG. 3 shows an illustrative hierarchy for the windows shown in FIG. 2; and

FIG. 4 shows illustrative method steps according to one embodiment of the invention.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

As indicated above, the invention provides an improved method, system and program product for processing requests in a web application. In particular, the invention provides a solution for ensuring that a page that may be displayed as a result of the request is displayed in a top level window. Specifically, under the present invention, a request may result in a login page or the like being provided to a client for display. The page can specify that it is to be displayed in a top level window. As a result, the ancestor window(s) for the active window can be located until an ancestor window is found that does not have a parent window, i.e., the ancestor window is a top level window. The page (e.g., login page) can then be displayed in the top level window. If the top level window has been closed, a new top level window can be created for displaying the page. Further, the active window and one or more ancestor windows can be closed so that the top level window becomes the active window for displaying the page.

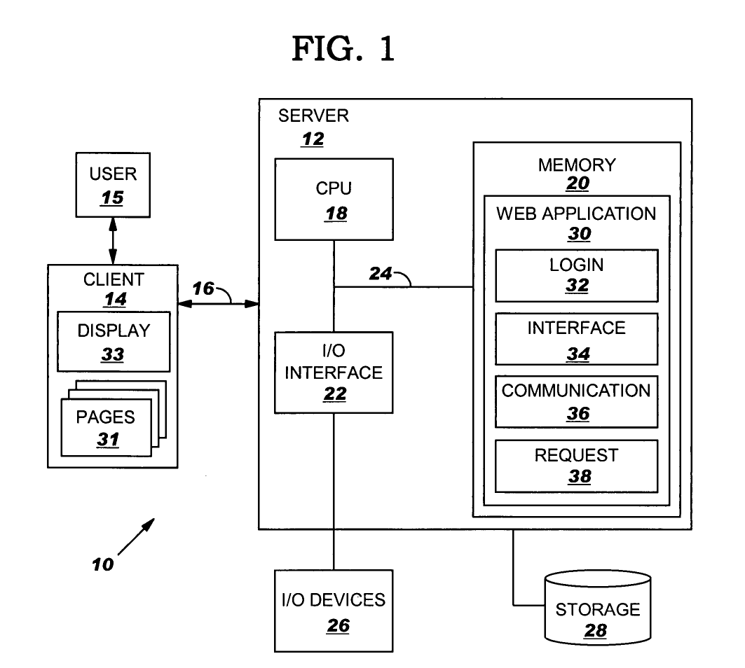

Turning to the drawings, FIG. 1 shows an illustrative system 10 for executing a web application 30 over a network 16. In particular, a user 15 operates a client 14 that generates requests for web application 30 that are communicated to server 12 over network 16. In response, web application 30 can provide one or more pages 31 for display on client 14 over network 16. To this extent, network 16 can comprise any type of communications link. For example, network 16 can comprise an addressable connection in a client-server (or server-server) environment that may utilize any combination of wireline and/or wireless transmission methods. In this instance, server 12 and client 14 may utilize conventional network connectivity, such as Token Ring, Ethernet, WiFi or other conventional communications standards. Further, network 16 can comprise any type of network, including the Internet, a wide area network (WAN), a local area network (LAN), a virtual private network (VPN), etc. Where client 14 communicates with server 12 via the Internet, connectivity could be provided by conventional TCP/IP sockets-based protocol, and client 14 could utilize an Internet service provider to establish connectivity to server 12.

As shown, server 12 generally includes a central processing unit (CPU) 18, a memory 20, an input/output (I/O) interface 22, a bus 24, external I/O devices/resources 26, and a storage unit 28. CPU 18 may comprise a single processing unit, or be distributed across one or more processing units in one or more locations, e.g., on a client and server. Memory 20 may comprise any known type of data storage and/or transmission media, including magnetic media, optical media, random access memory (RAM), read-only memory (ROM), a data cache, a data object, etc. Storage unit 28 may comprise any type of data storage for providing storage for information necessary to carry out the invention as described below. As such, storage unit 28 may include one or more storage devices, such as a magnetic disk drive or an optical disk drive. Moreover, similar to CPU 18, memory 20 and/or storage unit 28 may reside at a single physical location, comprising one or more types of data storage, or be distributed across a plurality of physical systems in various forms. Further, memory 20 and/or storage unit 28 can include data distributed across, for example, a LAN, WAN or a storage area network (SAN) (not shown).

I/O interface 22 may comprise any system for exchanging information to/from one or more external I/O devices 26. I/O devices 26 may comprise any known type of external device, including speakers, a CRT, LED screen, handheld device, keyboard, mouse, voice recognition system, speech output system, printer, monitor/display, facsimile, pager, communication hardware/software, etc. Bus 24 provides a communication link between each of the components in server 12 and likewise may comprise any known type of transmission link, including electrical, optical, wireless, etc. In addition, although not shown, additional components, such as system software, may be incorporated into server 12.

Further, it is understood that server 12 comprises any type of computing device capable of communicating with one or more other computing devices (e.g., client 14). Similarly, client 14 can comprise any type of computing device, such as a server, a desktop computer, a laptop, a handheld device, a mobile phone, a pager, a personal data assistant, etc. To this extent, client 14 typically includes the same elements as shown in server 12 (e.g., CPU, memory, I/O interface, etc.). These have not been separately shown and discussed for brevity. It is understood, however, that if client 14 is a handheld device or the like, a display could be contained within client 14, and not as an external I/O device 26 as shown for server 12.

Shown stored in memory 20 is web application 30, and shown implemented on client 14 is display system 33. Web application 30 is shown including a login system 32, an interface system 34, a communication system 36, and a request system 38. As noted, web application 30 provides one or more pages 31 to client 14 for display to user 15 using display system 33. As is common with many web applications 30, one or more pages 31 could include private and/or restricted data stored in, for example, storage system 28 that requires identification of user 15 before access to the data is allowed. To this extent, login system 32 can identify user 15 before interface system 34 provides these pages 31 to client 14. When user 15 operates client 14, one or more requests can be sent to server 12 and received by communication system 36. Request system 38 can determine whether the request requires authentication, and fulfill requests that are authorized. It is understood that the term “fulfill” means that the requested action is actually attempted. As a result, both a request that is successful, and a request that generates an error could be considered to be “fulfilled.”

When a page 31 is provided to client 14, display system 33 displays page 31 to user 15. Display system 33 can display multiple pages 31 in one or more windows. For example, display system 33 can create a window that displays a page 31. When another page 31 is subsequently received by client 14, display system 33 can use the same window to display the new page 31. In this case, the new page 31 can replace the previously displayed page 31, or some or all of both pages 31 can be displayed simultaneously within the window.

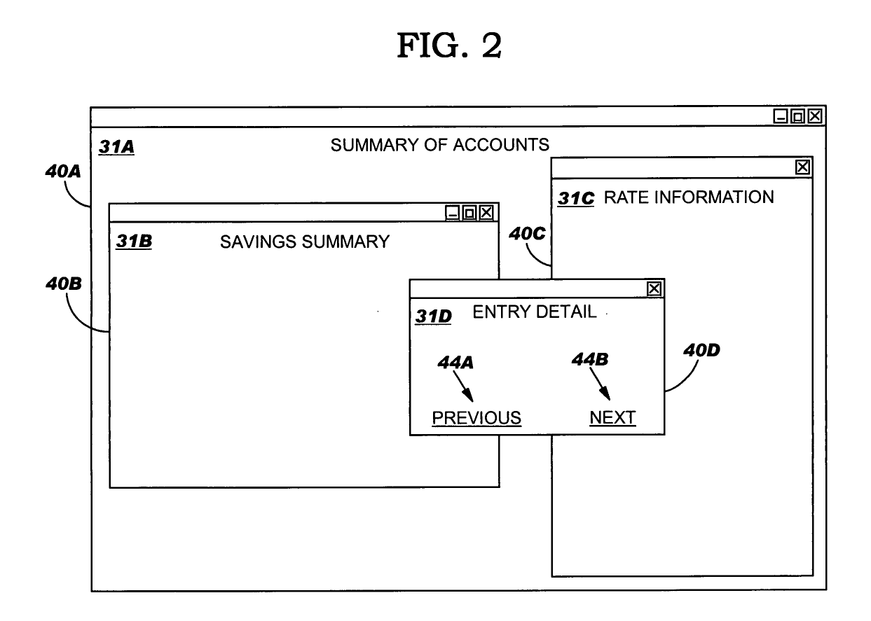

Alternatively, display system 33 can open a new window for displaying the new page 31. For example, FIG. 2 shows an illustrative set (one or more) of windows 40A-D for displaying pages 31A-D, respectively. As shown, display system 33 can vary the size and/or location of windows 40A-D on a display screen. Further, display system 33 can also allow user 15 (FIG. 1) to resize some or all of windows 40A-D. For example, windows 40A-B could be resizable by a user, while windows 40C-D are not. The various attributes for each window 40A-D (e.g., size, location, ability to resize, etc.) can be determined by display system 33, included in each page 31A-D, provided by web application 30 (FIG. 1) to display system 33 in a response, etc.

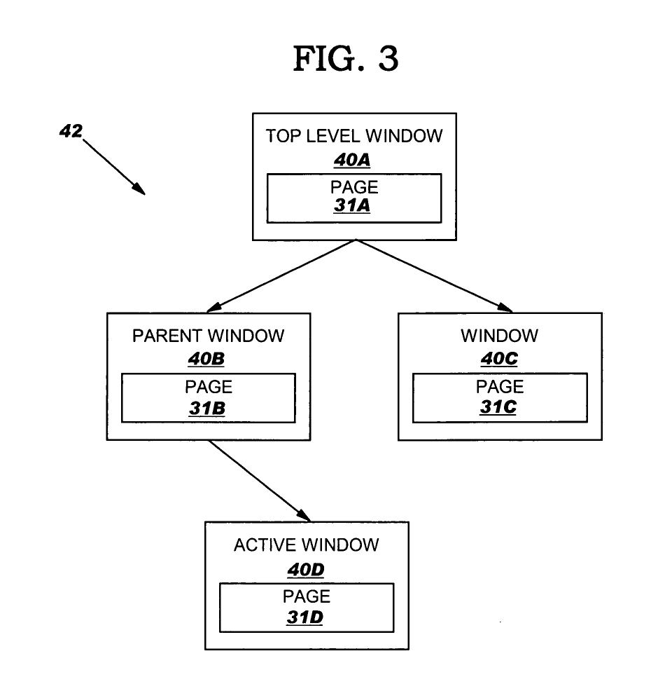

When multiple windows 40A-D are displayed, these windows 40A-D can have a hierarchical relationship. For example, FIG. 3 shows an illustrative hierarchy 42 that corresponds to windows 40A-D shown in FIG. 2. As shown, window 40A can comprise a top level window in hierarchy 42. The top level window of hierarchy 42 comprises the window located at the root (e.g., top) of hierarchy 42, and can comprise the first window (e.g., a main window) created by display system 33 (FIG. 1) for web application 30 (FIG. 1). As used in hierarchies, a window 40A-D that creates another window 40A-D is referred to as a “parent” of the newly created window, and the newly created window is referred to as a “child” of the previous window. As user 15 (FIG. 1) uses web application 30, top level window 40A can create one or more child windows, such as windows 40B-C, for displaying pages, such as pages 31B-C. Similarly, a child window 40B can create one or more of its own child windows, such as window 40D, for displaying pages 31D. In this case, window 40B is the parent of window 40D, and both windows 40A-B are “ancestors” of window 40D.

Referring to FIGS. 1-3, collectively, pages 31A-D illustrate one web application 30 in which hierarchy 42 of windows 40A-D can be used. As shown, top level window 40A displays a “summary of accounts” page 31A that includes information on various accounts, e.g., bank accounts, that user 15 can access using web application 30. For example, page 31A could include information on each account owned by user 15 (e.g., savings, checking, money market, etc.), such as a current balance, a last transaction date, etc. Prior to accessing page 31A, interface 34 can provide a welcome page to client 14 when web application 30 is initially run by user 15. The welcome page can be displayed in window 40A without identifying user 15, and can allow user 15 to select from various options (e.g., view accounts, general information, corporate information, etc.). Subsequently, user 15 can select to view his/her accounts, and a request can be sent to communication system 36 to view summary of accounts page 31A.

After receiving the request, communication system 36 can forward the request to request system 38 for processing. Initially, request system 38 can determine whether the request requires authentication. When authentication is required, login system 32 can provide a login page to client 14, and display system 33 can display the login page in window 40A. The login page can allow user 15 to enter login information that can be sent to login system 32 for authentication. When authentication is successful, the request can be fulfilled by request system 38. Otherwise, login system 32 can provide an error message for display to user 15, and the login page can be redisplayed.

In any event, once user 15 is successfully authenticated, request system 38 can fulfill the request to view page 31A. Request system 38 can obtain data on the appropriate accounts from, for example, storage unit 28. The data can be provided to interface system 34, which can generate a custom summary of accounts page 31A for user 15, and send page 31A to client 14. Display system 33 can then display page 31A in window 40A. After viewing the accounts information, user 15 may desire to obtain additional information on a particular account, e.g., a savings account. Page 31A can allow user 15 to request additional information by, for example, clicking on an account. A request can be sent to web application 30 for the additional information, request system 38 can fulfill the request, and interface system 34 can provide a “savings summary” page 31B to client 14. For example, request system 38 can obtain a list of all transactions for the particular account that occurred over a set time period. This information can be provided to interface system 34, which creates a cutom savings summary page 31B for display by display system 33. Further, page 31B and/or a response to the request can indicate that page 31B should be displayed in a new window 40B. In this case, display system 33 can create a new window 40B that is the child of window 40A and display page 31B in the new window 40B.

When a child window is created, the child window can be either non-modal or modal. A non-modal child window allows user 15 to make the parent window the active window without first closing the child window. For example, window 40B can be a non-modal window, and user 15 can reactivate window 40A while window 40B remains open. This allows user 15 to perform additional actions in window 40A. For example, user 15 can request rate information in window 40A. Web application 30 can process the request, and provide a “rate information” page 31C that includes the current interest rates for various accounts provided by the institution. Display system 33 can create another non-modal/modal child window 40C of window 40A to display page 31C.

When the child window is modal, user 15 must first close the child window in order to reactivate the parent window. For example, when window 40B is active, user 15 may request additional details on a particular transaction entry listed in page 31B. After processing the request, interface system 34 can provide an “entry detail” page 31D that is to be displayed in a new modal window 40D. Display system 33 can create the new window 40D and display page 31D therein. Should user 15 attempt to reactivate window 40B while window 40D is open, display system 33 would recognize that window 40D is modal, and would make/keep window 40D the active window. Once user 15 closes window 40D, window 40B can be reactivated.

As previously discussed, requests can be generated from any window 40A-D. For example, page 31D in window 40D includes a previous command 44A, and a next command 44B. When user 15 selects either command 44A-B, a request for the previous/next transaction entry listed in page 31B is generated and sent to web application 30 for processing. In either case, the request would require access to restricted/privileged data (e.g., details of a transaction for an account). As a result, as part of processing the request, request system 38 would determine whether the request requires authentication. If, for example, client 14 has not provided any requests that have been fulfilled by web application 30 for more than a time out period, request system 38 can require authentication before fulfilling the request. As a result, login system 32 can provide a login page to display system 33 for displaying to user 15.

As noted previously, child windows, such as windows 40B-D, are often created to display pages 31B-D that require a static, predictable amount of screen space. As a result, windows 40B-D can be created with a particular size, and/or may not be resizable by user 15. Consequently, when display system 33 receives the login page for display (i.e., as a result of a request generated from window 40D) window 40D may not be large enough to display the entire login page. Further, window 40D may not be able to be resized to display the entire login page. In order to address this problem, display system 33 can always display the login page in a top level window such as window 40A. Since window 40A is the first window created for web application 30, it is generally sized to include most of the display area and/or is resizable by user 15. As a result, window 40A should be able to display the entire login page.

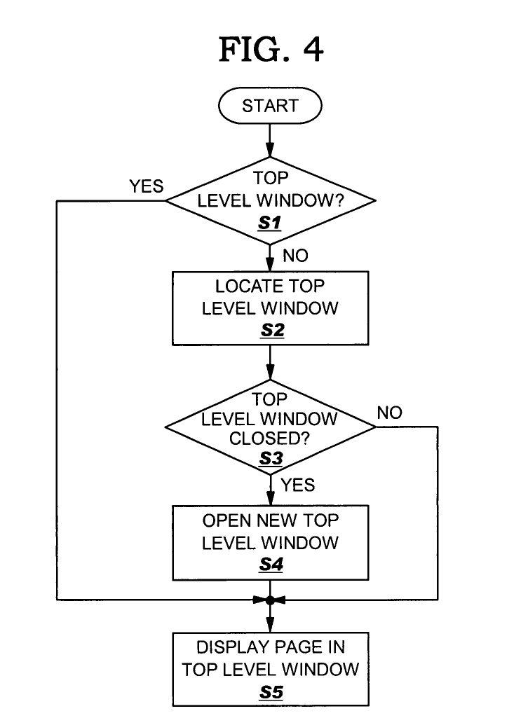

In one embodiment, when a request generated in window 40D requires authentication, the login page can ensure that display system 33 displays it in top level window 40A. In this case, the login page can include instructions (e.g., Java Script) that locate top level window 40A and display the login page in top level window 40A. FIG. 4 shows illustrative method steps that can be included at the start of the login page to ensure that it is displayed in window 40A. In step S1, the login page can first determine if the active window 40D is the top level window. If it is, then nothing further needs to be done, and the login page can be displayed in step S5. However, if window 40D is not the top level window, then the top level window is located in step S2. For example, each window 40A-D can include a parent attribute indicating whether the window has a parent, and if so, identifying the parent window. The login page can first determine that window 40D has a parent window 40B, and is therefore not a top level window. Starting with window 40B, the login page can analyze each ancestor window of window 40D in an identical manner until top level window 40A is located. In this case, the login page would recognize top level window 40A since its parent attribute would indicate that it does not have a parent window. It is understood that the login page can use different and/or additional information to determine the top level window. For example, each window 40A-D could include an attribute indicating whether it is a dialog window, an attribute indicating if it is a top level window, etc.

Once top level window 40A is located, in step S3 the login page can determine if top level window 40A is closed. If it is not closed, then the login page can specify top level window 40A to display it in step S5. For example, the login page can command display system 33 to display it in window 40A. When window 40D and/or window 40B are modal, display system 33 can also close these windows 40B, 40D so that top level window 40A can become the active window. Windows 40B and/or window 40D may also be closed when either or both are non-modal to return user 15 to a particular execution point in web application 30 (e.g., the accounts page). Alternatively, one or more non-modal windows 40A-D can remain open, and requests generated from these windows 40A-D can be processed by request system 38 after user 15 is authenticated.

However, the login page may determine that top level window 40A has been closed by user 15. For example, window 40A may create a non-modal child window 40B. Since window 40B is non-modal, user 15 can make window 40A the active window and close it. Window 40B may then create window 40D as a modal window, which generates a request that requires authentication. In this case, the login page would locate the top level window in step S2, however it determine in step S3 that it is closed. As a result, in step S4, a new top level window 40A can be opened. For example, the login page can command display system 33 to create a new top level window 40A, that is used to display the login page in step S5.

While various features of the invention have been shown and discussed with reference to displaying a login page, the invention is not limited to a login page. The invention can be used for displaying any type of page 31A-D that may be more effectively displayed by ensuring that a top level window 40A displays it. Further, it is understood that the window specified for displaying the page could be another window other than a top level window. For example, it could be determined that an intermediate ancestor window could effectively display the page since it is of a sufficient size and/or is resizable. As a result, the intermediate ancestor window could be used to display the page. Still further, while the invention is discussed with reference to the login page including instructions for locating the top level window, it is understood that login system 32 could provide a separate page that locates the top level window. Alternatively, a login page and/or a response provided by login system 32 could specify that display system 33 use the top level window, and display system 33 could locate the top level window.

It is understood that the present invention can be realized in hardware, software, or a combination of hardware and software. Any kind of computer/server system(s)—or other apparatus adapted for carrying out the methods described herein—is suited. A typical combination of hardware and software could be a general-purpose computer system with a computer program that, when loaded and executed, carries out the respective methods described herein. Alternatively, a specific use computer (e.g., a finite state machine), containing specialized hardware for carrying out one or more of the functional tasks of the invention, could be utilized. The present invention can also be embedded in a computer program product, which comprises all the respective features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

1. A method of processing a request in a web application, the method comprising:
obtaining a request that requires authentication;
locating an ancestor window for an active window of the web application; and
displaying a login page in the ancestor window.

2. The method of claim 1, further comprising generating the request in the active window.

3. The method of claim 1, further comprising closing the active window.

4. The method of claim 1, wherein the active window comprises a modal window.

5. The method of claim 1, wherein the ancestor window comprises a top level window.

6. A method of processing a request in a web application, the method comprising:
receiving the request from a client;
determining that the request requires authentication; and
providing a login page to the client, wherein the login page ensures display in a top level window.

7. The method of claim 6, further comprising:
receiving login information from the login page; and
authenticating the login information.

8. The method of claim 7, further comprising fulfilling the request when the login information is successfully authenticated.

9. The method of claim 6, wherein the determining step includes determining that a request has not been fulfilled for a client for more than a time out period.

10. The method of claim 6, wherein the login page ensures display in a top level window using the following steps:
locating an ancestor window for an active window for the web application; and
displaying the login page in the ancestor window.

11. The method of claim 6, wherein the login page ensures display in a top level window using the following steps:
determining that an ancestor window for an active window for the web application is closed;
opening a new top level window; and
displaying the login page in the new top level window.

12. A system for processing a request in a web application, the system comprising:
a communication system for receiving the request from a client;
a request system for determining whether the request requires authentication; and
a login system for ensuring that a login page is displayed in a top level window for the web application.

13. The system of claim 12, further comprising:
an interface system for providing pages to the client; and
a display system for displaying the pages in hierarchical windows on the client.

14. The system of claim 13, wherein the request is generated in a child window, and wherein the display system opens a new top level window to display the login page.

15. The system of claim 13, wherein the request is generated from a child window, and wherein the display system displays the login page in an ancestor window of the child window.

16. The system of claim 12, wherein the login system further receives login information and authenticates the login information.

17. A program product stored on a recordable medium for processing a request in a web application, which when executed comprises:
program code for obtaining the request from an active window for the web application, wherein the request requires authentication;
program code for locating a top level window for the web application; and
program code for displaying a login page in the top level window.

18. The program product of claim 17, wherein the program code for locating includes program code for determining that the active window is a child window.

19. The program product of claim 18, wherein the program code for locating further includes program code for locating an ancestor window for the active window.

20. The program product of claim 18, wherein the program code for locating further includes:
program code for determining that an ancestor window for the active window is closed; and
program code for opening a new top level window.
